(19) United States
(12) Patent Application Publication
(10) Pub. No.: US 2006/0269351 A1
(43) Pub. Date: Nov. 30, 2006

(54) Toothbrush having bristle portion and dentifrice container portion

(76) Inventor: Greg Kenneth McAfee, Bellbrook, OH (US)

Correspondence Address: ONEY & MURPHY, L.L.P., 6264 BRIDGEWATER CT., MASON, OH, 45040, US

(21) Appl. No.: 11/140,634

(22) Filed: May 27, 2005

(51) Int. Cl. A46B 11/00; B43K 5/06

(52) U.S. Cl. 401/125; 401/123

(57) ABSTRACT

A toothbrush having a bristle portion being adapted to provide oral care brushing benefits and a dentifrice storage portion being adapted to provide loose storage of a dentifrice. The dentifrice storage portion may or may not include the loose storage of dentifrice at the point of sale.

### FIELD OF THE INVENTION

This invention relates to a toothbrush having a bristle portion and a dentifrice container portion. More specifically, this invention relates to a toothbrush having a bristle portion and a dentifrice container portion capable of containing loose dentifrice.

### BACKGROUND OF THE INVENTION

Toothbrush and dentifrice combination kits are well known in the art. For example, U.S. Pat. No. 4,062,635, entitled “Automatic Tooth-Paste-Supplying Tooth Brush” discloses a toothbrush which comprises in combination, bristles, guide tube means and a source container from which a viscous substance is forced through apertures disposed near the bristles to the surface thereof. While this particular reference discloses the storage of dentifrice within a storage container, it requires the use of complex dispensing means (much like a thumbscrew deodorant applicator). This particular reference further requires the expulsion of dentifrice through orifices within the bristle head region. Consequently, The Sheng does not teach the use of an applicator as claimed by the present invention.

In another example, U.S. Pat. No. 4,265,560, entitled “Disposable Toothbrush With Self-Contained Toothpaste Supply”, discloses a disposable toothbrush with a self-contained toothpaste supply comprising a transparent handle section and an adjustable brush head having outstanding bristles secured thereto. While this particular reference discloses the storage of dentifrice within a storage container, it requires the use of compression force about the handle so as to expel dentifrice through orifices within the bristle head region. Consequently, Spica does not teach the use of an applicator as claimed by the present invention.

In yet another example, U.S. Pat. No. 4,375,924, entitled “Paste Dispenser Tooth-Brush”, discloses a paste dispenser toothbrush comprising an intermediate tubular body, a toothbrush head secured at one end of the intermediate body, a toothpaste supply cartridge at the other end of the intermediate body, a cover fitting over the toothbrush with a toothpaste axial passage in the intermediate body, the latter forming a piston at one end screwing in the toothpaste supply cartridge to expel the toothpaste toward the toothbrush through the axial passage. While this particular reference discloses the storage of dentifrice within a storage container, it requires the use of complex screw threads to expel dentifrice through orifices within the bristle head region. Consequently, Lemire does not teach the use of an applicator as claimed by the present invention.

In yet another example, U.S. Pat. No. 5,476,334, entitled “Foldable Toothbrush With Toothpaste”, discloses a foldable toothbrush having a cavity formed in a forward member and adapted to store a packet of toothpaste. While this particular reference discloses the storage of dentifrice within a storage container, it requires the use of toothpaste being stored in packets that are subsequently ruptured by fins. Consequently, Tello-Vallarino does not teach the use of an applicator as claimed by the present invention, nor does it teach the loose storage of dentifrice.

In yet another example, U.S. Pat. No. 5,862,817, entitled “Two-in-One Toothbrush Unit”, discloses a two-in-one toothbrush unit comprising a toothbrush and toothpaste featuring an accommodating hole on the handle of the toothbrush so that the toothpaste can be accommodated in the accommodating on the brush handle and the toothpaste may be wrapped by an adhesive paper label. While this particular discloses the storage of dentifrice within the handle of the toothbrush, it requires the use of a pre-packaged dentifrice such as a tube. Consequently, Lee does not teach the use of an applicator as disclosed by the present invention, nor does it teach the loose storage of dentifrice.

What is needed is a toothbrush having a bristle portion and a dentifrice container portion capable of containing loose dentifrice.

### SUMMARY OF THE INVENTION

A toothbrush having a bristle portion being adapted to provide oral care brushing benefits and a dentifrice storage portion being adapted to provide loose storage of a dentifrice. The bristle portion may have a stem portion. The stem portion having a first and second end. A plurality of bristles may extend from said first end of said stem portion. Said bristles being adapted to receive applied-dentifrice. Said bristles being adapted to provide oral care brushing benefits. The dentifrice storage portion may have a container body. The container body having a first and second end. The first endcap being affixed to said first end of said container body. The first endcap being affixed to said second end of said stem portion. The second endcap being releasably affixed to said second end of said container body. An applicator may also be included. The applicator being adapted to remove dentifrice from said container body and adapted to apply the dentifrice to said plurality of bristles. An applicator stem may also be included. The applicator stem having a first and second end. The first end of said applicator stem being affixed to said applicator. The second end of said applicator stem being affixed to said second endcap. The applicator stem being sufficiently elongated so as to allow said applicator to adequately swipe the dentifrice from said container body. The container body may or may not include the loose storage of dentifrice at the point of sale.

### BRIEF DESCRIPTION OF THE DRAWINGS

While the specification concludes with claims particularly pointing out and distinctly claiming the subject matter that is regarded as the present invention, it is believed that the invention will be more fully understood from the following description taken in conjunction with the accompanying drawings. None of the drawings are necessarily to scale.

FIG. 1 is a perspective view of a toothbrush in accordance with the present invention;

FIG. 2 is a perspective view of the toothbrush from FIG. 1 with the end cap partially removed;

FIG. 3 is a bottom view of the end cap and attached applicator from FIG. 2 being fully removed from the toothbrush;

FIG. 4 is a right side elevation of the end cap and applicator from FIG. 3; and

FIG. 5 is a ride side elevation of the toothbrush from FIG. 1 with a cut-out view of the dentifrice container portion wherein loose dentifrice and the applicator are observable.

### DETAILED DESCRIPTION OF THE INVENTION

Definitions:

The term “dentifrice” herein refers to a powder, paste, or liquid for cleaning the teeth and/or gums.

The term “loose dentifrice” herein refers to dentifrice which is dispensed into the container body in its raw product form, such as from a separate tube of dentifrice. The term “loose dentifrice” herein does not refer to dentifrice which is pre-packaged for package-insertion into the toothbrush.

The term “joined” encompasses configurations whereby an element is directly secured to another element by affixing the element directly to the other element, and configurations whereby an element is indirectly secured to another element by affixing the element to intermediate member(s) which in turn are affixed to the other element.

Description:

While toothbrush and dentifrice combination kits are well known in the art, such kits are often mechanical complex and/or require the use of dedicated dentifrice packets. Such mechanical complexity increases the cost. Such reliance on dedicated dentifrice packets decreases flexibility for the consumer. The present invention, however, provides an inexpensive and flexible combination kit. More specifically, the toothbrush of the present invention provides primary brushing capability and novel dentifrice storage/application means.

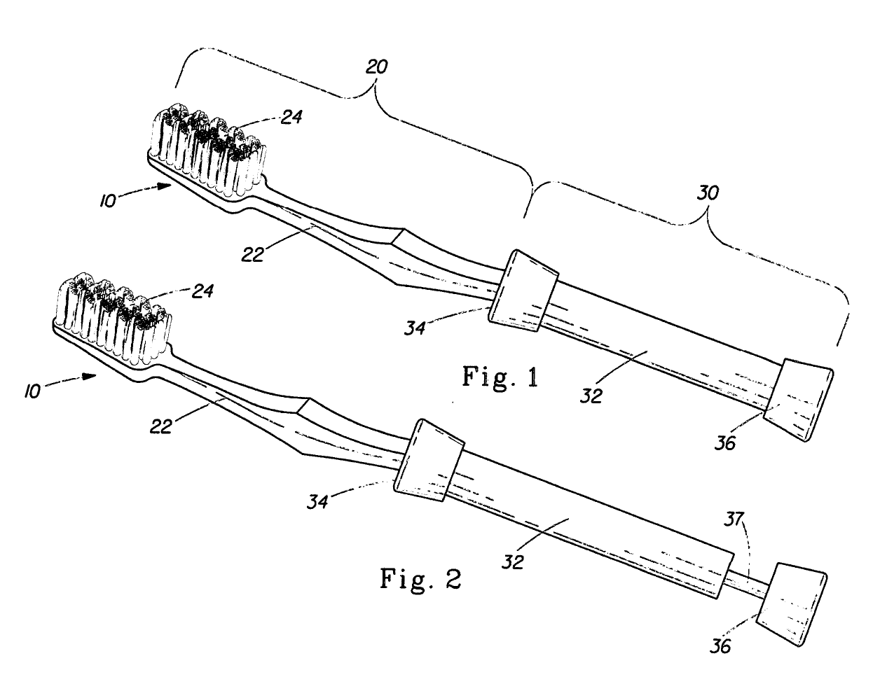

Referring now to FIG. 1, a toothbrush 10 is shown having a bristle portion 20 and a dentifrice container portion 30. Said bristle portion 20 may comprise of a stem portion 22 and a plurality of bristles 24 extending therefrom. Said dentifrice container portion 30 may comprise of a container body 32 which is capable of storing loose dentifrice (see FIG. 5). Said dentifrice may be supplied from an external tube or other like packages (not shown). Said dentifrice container portion 30 may also comprise a first endcap 34 and a second endcap 36. Said first endcap 34 provides closure means for said container body 32 and also provides a structural connection for said stem portion 22. Said second endcap 36 provides closure means for said container body 32 in a removable fashion. Further, said second endcap 36 includes an attached applicator 38 and applicator stem portion 37 connected therebetween. Referring now to FIG. 2, second endcap 36, applicator stem portion 37 and applicator 38 may be removed from dentifrice container portion 30 to permit supplying of dentifrice into said container portion, or to permit extraction and subsequent application of dentifrice on bristles 24.

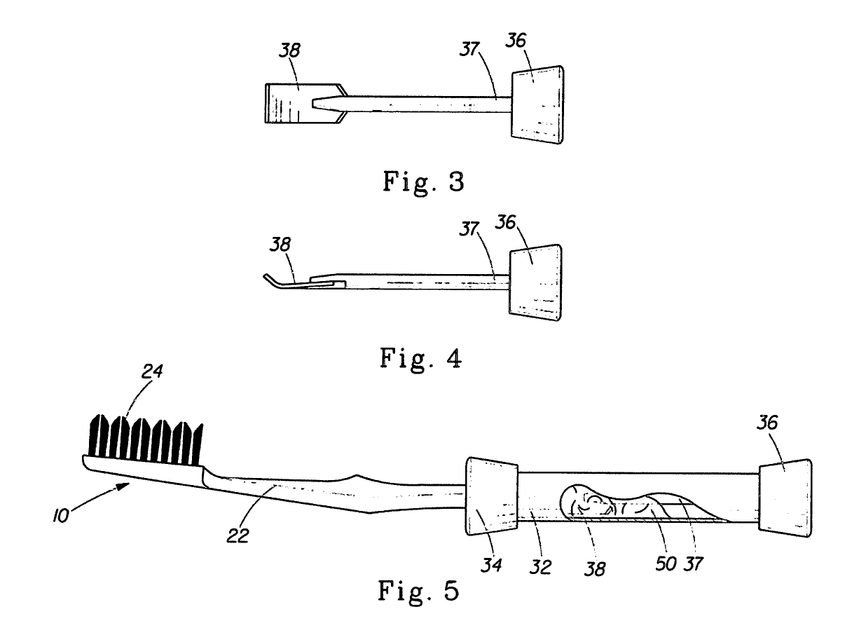

FIG. 3 depicts an exemplary construction of second endcap 36, applicator stem portion 37 and applicator 38. While one skilled in the art would appreciate a variety of constructions, said applicator stem 37 should remain sufficiently elongated so as to permit substantial extraction of loose dentifrice from dentifrice container portion 30. Further, said applicator stem may be rigid or semi-flexible so long as it serves its primary functionality. Additionally, said applicator 38 should remain sufficiently capable of extracting and applying loose dentifrice. While applicator 38 is shown to be fin-shaped, one skilled in the art would appreciate other suitable geometries including, but not limited to, bulb-shaped and bristle-formed. Referring now to FIG. 4, it may be seen that applicator 38 may include an angled portion to further facilitate extraction of loose dentifrice.

Referring now to FIG. 5, container body 32 is shown having a cut-out view so that loose dentifrice 50, and the storage thereof, may be seen. As can be further appreciated, container body 32 provides for clean containment of said loose dentifrice and said applicator while also providing a gripping portion for use during brushing. Said container body 32 may or may not include the loose storage of dentifrice at the point of sale (i.e., time of purchase by the consumer).

Further, said container body may be constructed in such a way as to make easy the loading of dentifrice. For example, the diameter of the container body should be sufficiently large enough to facilitate such loading. Additionally, one skilled in the art would appreciate various packaging design techniques for permitting air to escape during loading.

All documents cited herein are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

For example, one skilled in the art would appreciate that many of the parts herein may be constructed as integral parts and/or discrete parts.

For example, one skilled in the art would appreciate that said toothbrush may be constructed of a variety of suitable materials including, but not limited to, polypropylene and polyethylene. Said bristles may be constructed of any suitable material, such as those already prevalent in the art.

For example, one skilled in the art would appreciate a variety of fasteners connected to said toothbrush so as to permit ease of carrying. For instance, a hook may be attached to the end of said end cap.

What is claimed is:

1. A toothbrush comprising:
a bristle portion being adapted to provide oral care brushing benefits; and
a dentifrice storage portion being adapted to provide loose storage of a dentifrice.

2. The toothbrush of claim 1 wherein said bristle portion comprises:
a stem portion, said stem portion having a first and second end; and
a plurality of bristles extending from said first end of said stem portion, said bristles being adapted to receive applied-dentifrice, said bristles being adapted to provide oral care brushing benefits.

3. The toothbrush of claim 2 wherein said dentifrice storage portion comprises:
a container body, said container body having a first and second end;
a first endcap being affixed to said first end of said container body, said first endcap being affixed to said second end of said stem portion;
a second endcap being releasably affixed to said second end of said container body;
an applicator, said applicator being adapted to remove dentifrice from said container body and adapted to apply the dentifrice to said plurality of bristles; and
an applicator stem, said applicator stem having a first and second end, said first end of said applicator stem being affixed to said applicator, said second end of said applicator stem being affixed to said second endcap, said applicator stem being sufficiently elongated so as to allow said applicator to adequately swipe the dentifrice from said container body.

4. The toothbrush of claim 3 wherein said container body contains loose storage of
dentifrice at the point of sale.

5. The toothbrush of claim 3 wherein said container body does not contain loose
storage of dentifrice at the point of sale.
